(19) United States
(12) Patent Application Publication
(10) Pub. No.: US 2026/0175421 A1
(43) Pub. Date: Jun. 25, 2026

(54) Automatic Compensation for Non-Deterministic Errors in a Robotic Assembly System

(71) Applicant: Bright Machines, Inc., San Francisco, CA (US)

(72) Inventors: Emmanuel Gallo, Oakland, CA (US); Yue Han, San Francisco, CA (US); Victoria Ruth Colthurst, San Francisco, CA (US); Yuan-Chih Peng, San Francisco, CA (US); Jiacheng Yuan, San Mateo, CA (US); Murali Pappoppula, Fremont, CA (US)

(73) Assignee: Bright Machines, Inc., San Francisco, CA (US)

(21) Appl. No.: 19/430,235

(22) Filed: Dec. 22, 2025

Related U.S. Application Data
(60) Provisional application No. 63/738,748, filed on Dec. 24, 2024.

(51) Int. Cl. B25J 9/16

(52) U.S. Cl. CPC B25J 9/1641; B25J 9/1697

(57) ABSTRACT

A method of compensating for non-deterministic errors in a robotic cell including a robot arm with an end of arm tool, one or more static cameras on the robotic cell, and one or more tip-view cameras on the robot arm, the method comprising using the one or more static cameras for targeting movement during a first phase of movement to a first position, and using the one or more tip-view cameras for targeting the movement during a second phase or subsequent phases, images from the tip-view cameras used to calculate an offset defining a difference between the first position and an intended position.

### RELATED APPLICATIONS

The present invention claims priority to U.S. Provisional Application No. 63/738,748, filed on Dec. 24, 2024, and incorporates that application in its entirety.

### FIELD

The present invention relates to robotic assembly, and in particular to using end of arm sensor to compensate for a combination of non-deterministic errors.

### BACKGROUND

Robotic assembly systems generally include a robot arm which is controlled by software. Part of the information that the software uses to control the robot arm is information from one or more cameras.

In traditional robotic cell assembly systems, the cameras are coupled to the top of the robotic cell and are used to guide the movement of the robot arm. However, such overhead cameras are obstructed by the robot arm, as it nears the assembly location, or socket.

One way to address an inaccuracy in the movement is by manually controlling the robot arm to correct for any such issue. Similarly, adjustment of assembly for deviations in the component or socket would need to be corrected using manual controls.

### BRIEF DESCRIPTION OF THE FIGURES

The present invention is illustrated by way of example, and not by way of limitation, in the figures of the accompanying drawings and in which like reference numerals refer to similar elements and in which:

FIG. 1A is a diagram of one embodiment of a robotic cell including a robot arm, a static sensor and a tip-view sensor.

FIG. 1B is one embodiment of the high level specification design of the system.

FIG. 2A is one embodiment of a simplified end of arm component with end of arm sensors, holding a DIMM for insertion into a DIMM socket.

FIG. 2B is one embodiment of the simplified end of arm component with miniature end of arm cameras in the insertion position.

FIG. 2C is one embodiment of a side view of the simplified end of arm component in the insertion position, showing the portion seen by the tip-view sensors.

FIG. 2D is one embodiment of a simplified end of arm with a plurality of sensors mounted for 360 degree coverage.

FIG. 2E is an embodiment of a simplified view of an end of arm with a tip-view sensor for inserting a CPU component into a socket.

FIG. 2F is one embodiment of a partial view of the socket and CPU component for insertion, as seen by the tip-view sensor of FIG. 2E.

FIG. 3 is an overview flowchart of one embodiment of using the static sensor and the tip-view sensor.

FIG. 4A is a flowchart of one embodiment of the process of using the static sensor and the tip-view sensor for calibrating a robotic cell.

FIG. 4B is a flowchart of one embodiment of the process of using the static sensor and the tip-view sensor for a re-trying a process.

FIG. 4C is a flowchart of one embodiment of the process of using the static sensor and the tip-view sensor for macro-micro movements.

FIG. 5 is a detailed flowchart of one embodiment interaction between an assembly recipe and a perception device driver.

FIG. 6 is a flowchart of one embodiment of the insertion process.

FIG. 7 is an image of one embodiment of the end of arm tool including two end of arm tip-view cameras.

FIG. 8 is an image of another embodiment of the end of arm tool including two miniature end of arm tip-view cameras.

FIG. 9 is an image of one embodiment of the socket and DIMM from one of the end of arm tip-view cameras.

FIGS. 10A-10C are images of the gripper end of arm holding a component, with different alignments, as seen by a tip-view sensor.

FIGS. 11A-11C are images of a DIMM socket latch in different states, as seen by a tip-view sensor.

FIG. 12 is an image of one embodiment of the end of arm tool including two end of arm cameras for calculating a location offset, using a fiducial.

FIG. 13 illustrates the sockets as identified by the occlusion-resilient key point detection.

FIG. 14A is a flowchart illustrating an alternative method of calculating an offset.

FIG. 14B illustrates the system implementing the process of FIG. 14A.

FIG. 15 is a flowchart illustrating one embodiment of training a neural network.

FIG. 16 is a block diagram of one embodiment of a computer system that may be used with the present invention.

### DETAILED DESCRIPTION

The present system provides an automatic adjustment method to adjust for deviations in a robotic assembly system. The present system provides a method and apparatus for compensating for non-deterministic errors and variation in a robotic cell, a robot arm movement, or the parts for assembly. The system uses a combination of data from static or environmental view sensor(s) and tip-view sensor(s). The static sensor may be a camera, or other sensor coupled to the top of the robotic cell, which provides a global view of the working volume of the robotic system. The tip-view sensor may be a camera or other sensor which provides a close-up view of the insertion area(s) for the robotic cell. In one embodiment, the tip-view sensor may be a camera coupled to the robot arm. The automatic adjustment method may be used for different phases of the system, including one or more of calibration, multi-stage movement, insertion or assembly steps, and error correction.

In one embodiment, for calibration of a robotic cell, a first phase uses the static sensor for calibration. A second phase uses the tip-view sensor for a second phase of calibration. The multi-layer calibration enables the robotic cell to be adjusted for physical deviations between the reference robotic cell for which a software program was written and the actual robotic cell being calibrated. The calibration can also be used to adjust the robotic cell to account for physical changes to the robotic cell over time.

In one embodiment, the sensor combination may also be used for a two-phase insertion process during production. In this use, a first phase is a macro movement to align a component being held by the robot arm for assembly with a socket or other destination for the component. The first phase uses the static sensor, in one embodiment. In another embodiment, the first phase may use a combination of the static and tip-view sensors. The second phase provides any needed micro-movements to adjust for any deviations in the component, the socket, and/or the robot system, using the tip-view sensor.

In one embodiment, the sensor combination may also be used for error correction. In this use, the static sensor is used for an initial insertion attempt, in one embodiment. In another embodiment, a combination of the static sensor and the tip-view sensor is used for the initial insertion attempt. If the initial insertion attempt fails, the system automatically retries insertion using a two phase insertion process with the tip-view sensor. In this embodiment, for standard insertions, the tip-view sensor is not utilized. This speeds up the process, as the data from the tip-view sensor does not need to be analyzed. However, when an insertion failure is detected, the system automatically retries insertion using the tip-view sensor. This enables the system to correct for any deviations in the component or the socket and/or the robotic system. In one embodiment, this approach uses the two phase macro-micro movement approach described above for the error correction phase only.

Thus, the present application describes a system which provides correction for deviations in the robotic cell, robot arm, component, and/or socket, using a combination of a static sensor and a tip-view sensor.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. For example, the illustrated examples focus on a particular use case - inserting a memory module into a socket. However, it should be understood that the process can be used for a variety of tasks including navigation, picking up components, insertion of different types of components into sockets or other receptacles, and/or attaching components to a part being assembled for example with screws or other attachment mechanisms. The correction mechanisms described can be used for any function which requires high accuracy positioning of a robotic arm or tool tip. The following detailed description is, therefore, not to be taken in a limiting sense, and the scope of the present invention is defined only by the appended claims.

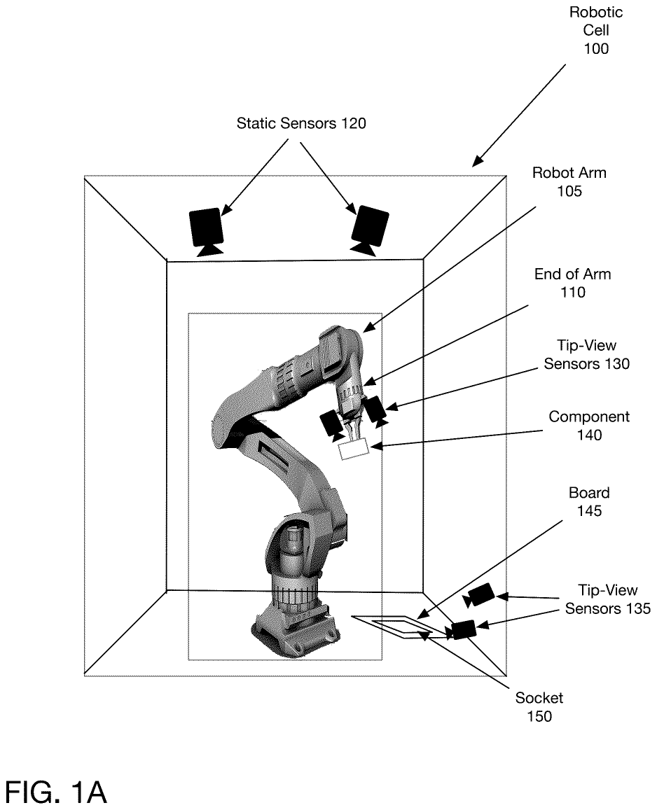

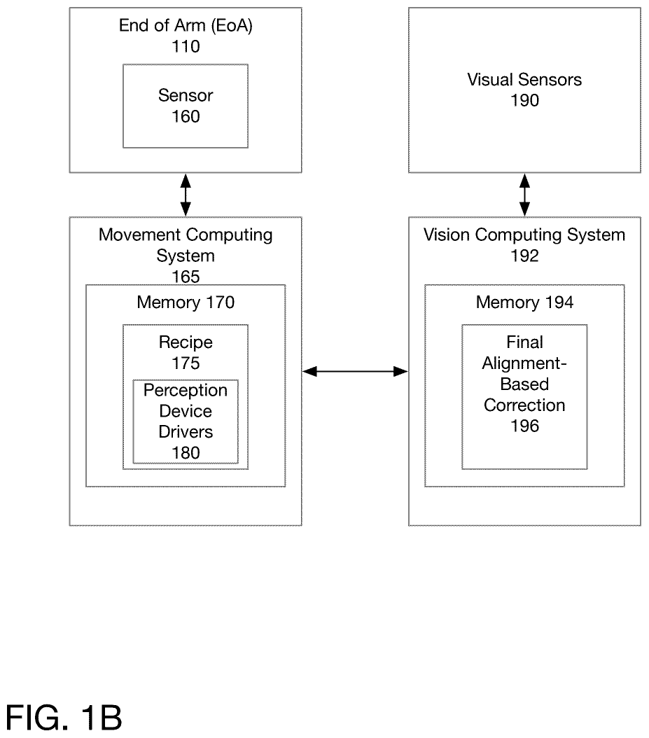

FIG. 1A is a diagram of one embodiment of a robotic cell including a robot arm, a static sensor and a tip-view sensor. The robotic cell 100 is an enclosure within which a robot arm 105 can move to assemble an item. The item may be for example a printed circuit board (PCB) including one or more of central processing units (CPUs), graphics processing units (GPUs), memory boards, heat sinks, and other components. The item may be another type of computer part, another type of electronic part, or any another type of item including one or more components.

The robot arm 105 is controlled via software to assemble the item, in one embodiment. The assembly may include placing components 140 into sockets 150 or other receptacles. It may also include screwing in or otherwise attaching components to sockets, each other, or to other parts. It may also include opening latches, sockets, or other parts and moving or removing components or parts during the assembly.

The actual item being assembled is not constraining, and while the present application provides examples for insertion of a component into a socket, one of skill in the art would understand that the process can be applied to any step in the assembly or disassembly of any item using the robotic cell.

In some embodiments, the assembly utilizes a series of robotic cells, together referred to as a micro factory, and each robotic cell performs one or more actions in an assembly sequence. For example, for assembling a printed circuit board, one robotic cell may insert a CPU while another inserts one or more memory components into the printed circuit board, and a third places and attaches a heat sink to the board. In one embodiment, a single cell may be used for two steps, such as inserting a component and attaching the component securely. In one embodiment, the robotic cell may use different processes for the different steps, e.g., using the macro-micro approach for an insertion step, and the error-correction approach for the attachment step, or vice versa. In some embodiments, the same process may be used for all of the assembly steps.

The robot arm 105 includes an end of arm 110. The end of arm 110 in one embodiment may be a tool or part configured for the action to be taken by the robotic cell. For example, for inserting a memory module component 140 into a socket 150, the end of arm 110 may include a gripper to hold the component, latch openers to open the socket latches, and one or more sensors to control the insertion of the memory module into the socket.

The robot arm 105 is guided in one embodiment based on data from one or more sensors 120, 130, 135. In one embodiment, the system includes static sensors 120. The static sensors 120 are coupled to a rigid frame of the robotic cell 100 in one embodiment. The static sensors 120 provide a global or environmental view of a working area of the robotic cell 100—the interior of the robotic cell defined by the space in which the robotic arm performs work. In one embodiment, static sensors 120 are one or more cameras, which cover the entire working area, of the robotic cell 100. In one embodiment, the static sensors 120 may be 2D cameras. In some embodiments, the static sensors 120 may be 3D sensors, distance sensors, 3D cameras, and/or other components that can be used to provide a “view” of the robot arm and end of arm and thus be used for positioning data for the robot arm 105. A single robotic cell may include a plurality of sensors.

In addition to static sensors 120 which provide a global view, the system also includes tip-view sensors 130 and/or 135. The tip-view sensors 130 and/or 135 provide a close-up of the components/socket during calibration and/or assembly and are used to ensure alignment. Tip-view sensors in one embodiment are end of arm sensors 130. End of arm sensors 130 are coupled to the end of arm component of the robot arm. In another embodiment, tip-view sensors may be stationary sensors 135 positioned in close proximity to the socket or base 145 where the assembly is occurring, and positioned so they can see the alignment of parts, as will be described in more detail below. The tip-view sensors 130 and/or 135 in one embodiment are cameras. In one embodiment, the tip-view sensor 130 and/or 135 includes a plurality of 2D cameras. In one embodiment, the tip-view sensor 130 and/or 135 include a plurality of different sensors including 3D sensor, depth sensor, or other components that can provide a close-up alignment “view” of the parts.

In one embodiment, the number of tip-view sensors may be based on the configuration of the components of the item being assembled. For example, for a DIMM (double inline memory module) board, there may be two cameras, one for each side, corresponding to the slots in the socket into which the DIMM is inserted. For example, for a CPU, there may be four cameras, one for each corner of the socket into which the CPU is inserted. For attaching a component, there may be a tool-tip view sensor for each bracket, screw, or attachment mechanism that requires alignment.

FIG. 1B is one embodiment of the high level specification design of the system. The system includes an end of arm 110, which is coupled to the robot arm. The end of arm 110 in one embodiment includes a sensor 160. The sensor 160 is used to provide feedback to the system about the insertion. In one embodiment, the sensor 160 is a load cell which senses force. In one embodiment, the load cell uses a transducer to convert force into electrical output. The load cell in one embodiment is used to sense the force of insertion, for a configuration in which the end of arm inserts a component into a socket or other location. In one embodiment, if the end of arm is a different tool, the sensor 160 may be a different sensor, which is appropriate for the tool and assembly step.

The system further includes movement computing system 165 and vision computing system 192. The movement computing system 165 includes memory 170, which includes a recipe 175 to control the movement of the robot arm and end of arm 110. The recipe in one embodiment includes one or more perception device drivers 180. A perception device driver 180 translates a recipe to a series of steps based on data from one or more sensors and permits the recipe to be based on an action to be taken (e.g., tighten screw) rather than specifying the movements. However, to use a perception device driver, the system must be aware of the exact position of the tool tip, to ensure that the action is taken in the correct position and alignment.

Vision computing system 192 provides information from visual sensors 190 to locate the end of arm 110, tool tip, and components. In one embodiment, visual computing system 192 includes memory 194, which stores instructions to take a final alignment-based correction 196 prior to completing the assembly action. The final alignment-based correction 196 is used, in one embodiment, to move from a recipe to vision-based movement for the last portion of an assembly action. It provides an alignment-based correction for small discrepancies at the last stage, as described below in more detail.

In one embodiment, the movement computing system 165 and vision computing system 192 are implemented in the same device. In one embodiment, the movement computing system 165 and vision computing system 192 may be running on a local computing system within the robotic cell. In another embodiment, the movement computing system 165 and vision computing system 192 may run on a remote server, or one or more remote devices, or cloud devices. In another embodiment, some aspects of the movement computing system 165 and vision computing system 192 may be remote, while others are local. In some embodiments, the local computing system (and the remote computing system) includes one or more processors, such as one or more central processing units (CPUs) and graphics processing units (GPUs), as well as memory, and other components.

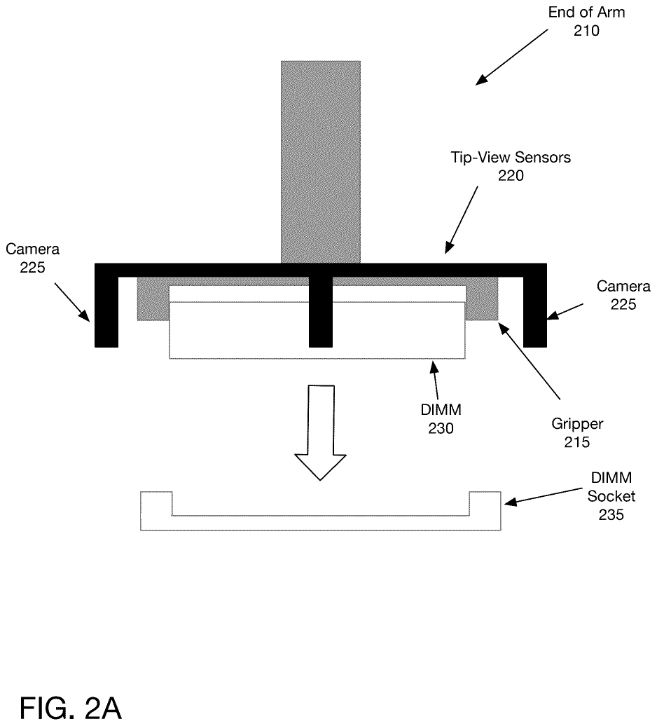

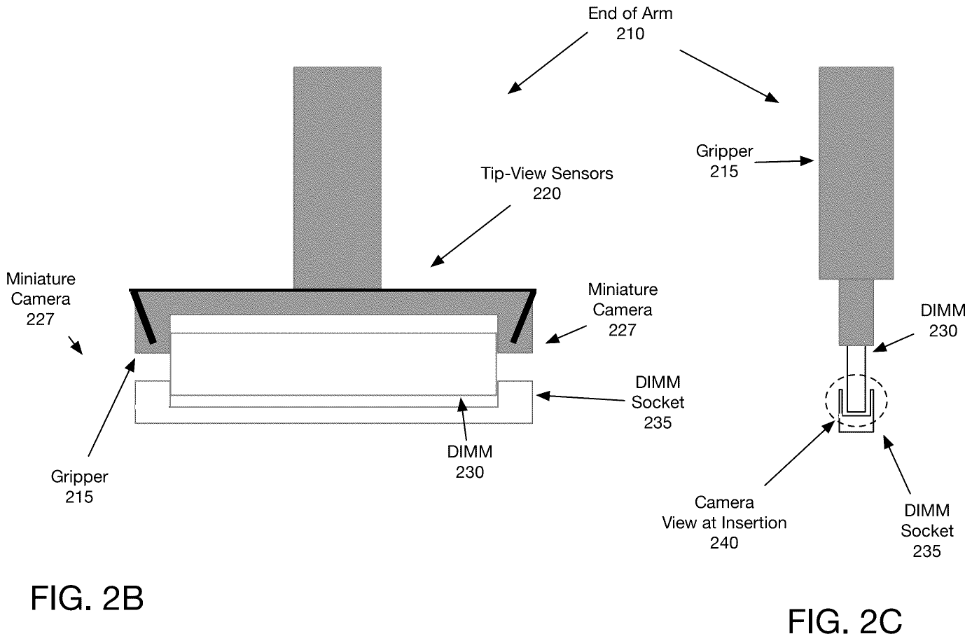

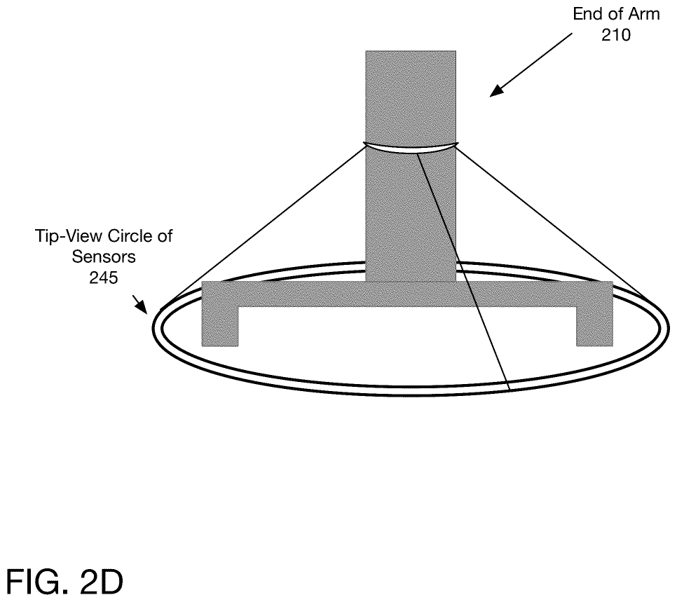

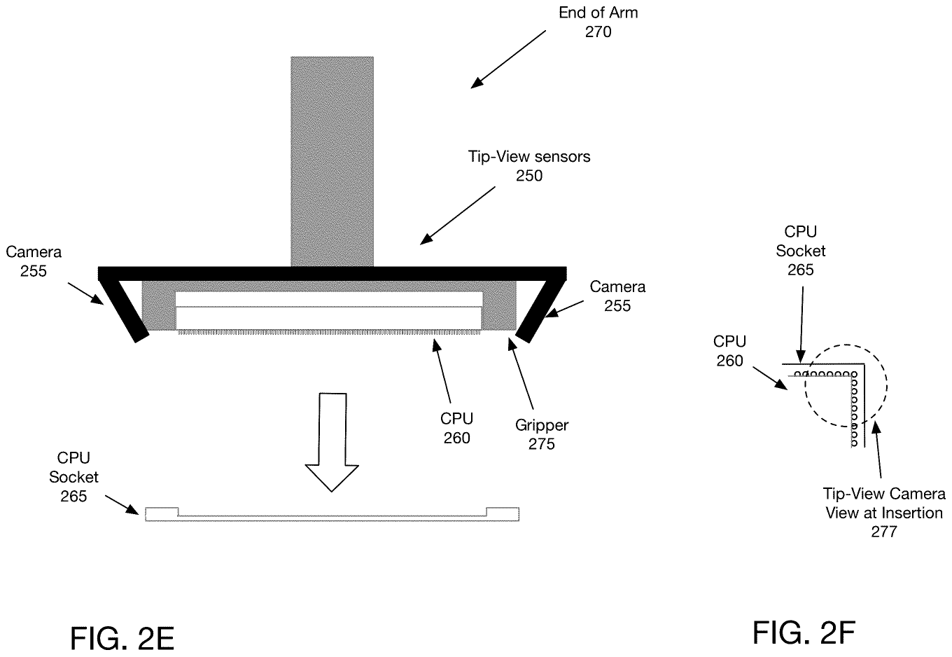

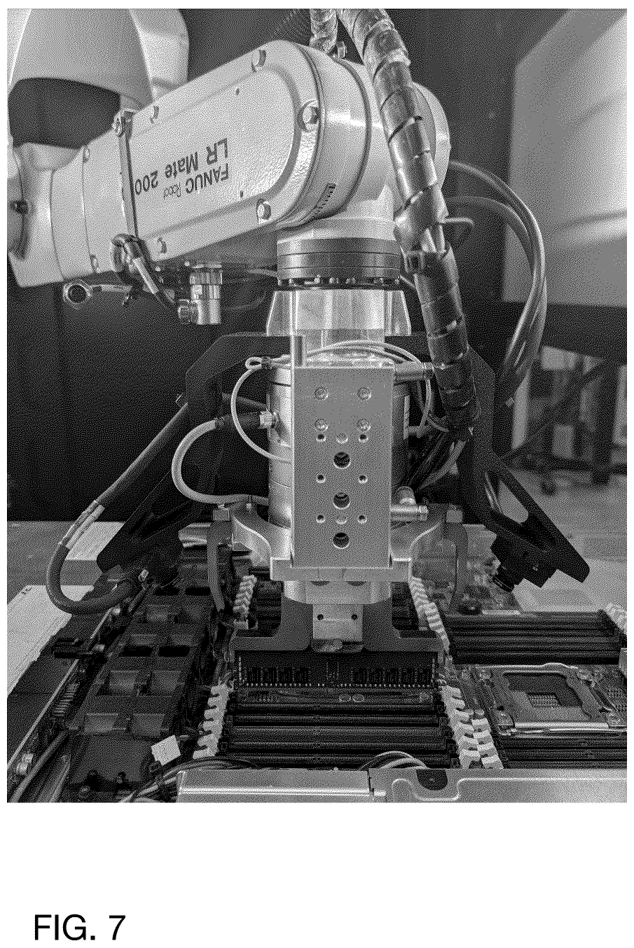

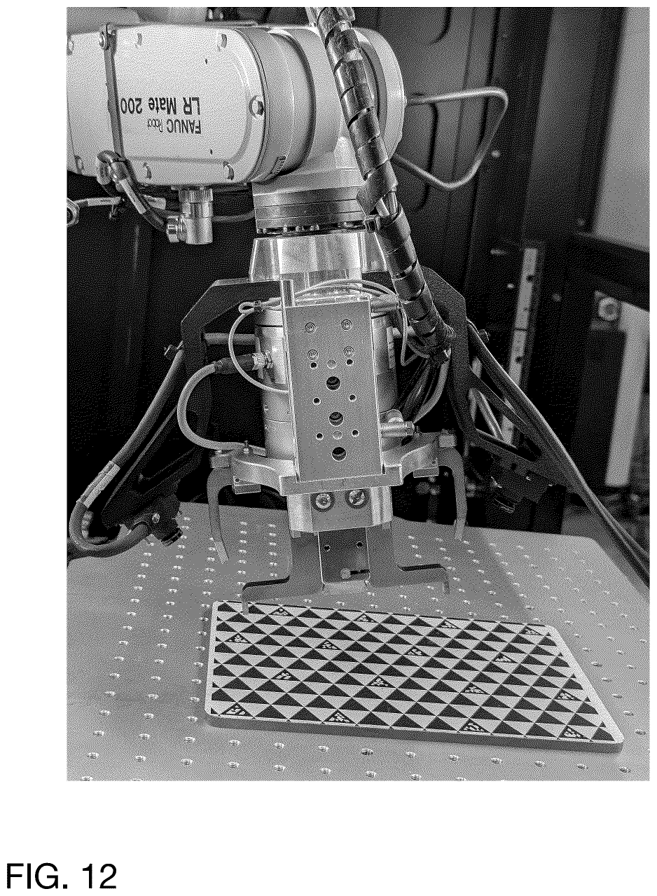

FIG. 2A is one embodiment of a simplified end of arm component with tip-view sensors. The end of arm 210 is coupled to the robot arm (not shown). The end of arm 210 includes a gripper 215, for gripping a component. In this example illustration the component is DIMM 230. The end of arm 210 also includes tip-view sensors 220. In this illustration, the tip-view sensors are cameras 225, which are positioned to see the tool tip at the point of insertion. The tool tip in this configuration would be the contact area of the DIMM 230, as it is inserted into DIMM socket 235. FIG. 7 is a more detailed image of one embodiment of the end of arm tool including two end of arm cameras. FIG. 12 is an image of one embodiment of an end of arm tool including two end of arm cameras for calibration using a fiducial.

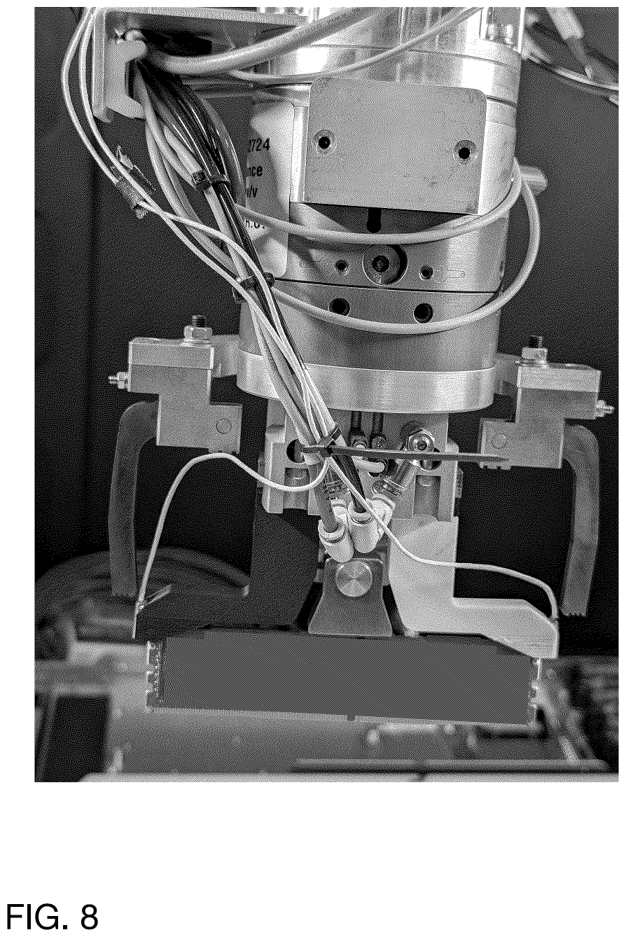

FIG. 2B is one embodiment of the simplified end of arm component with miniature cameras used as the tip-view cameras in the insertion position. In this configuration, the tip-view sensors 220 are miniature cameras 227, attached to the end of arm 210. In one embodiment, the miniature cameras are mounted on the gripper fingers to provide even further close-up view. In one embodiment, the miniature cameras 227 are video borescopes. The miniature cameras are configured to view the insertion point where component alignment can be seen. FIG. 8 is a more detailed image of one embodiment of the end of arm tool including two miniature end of arm cameras.

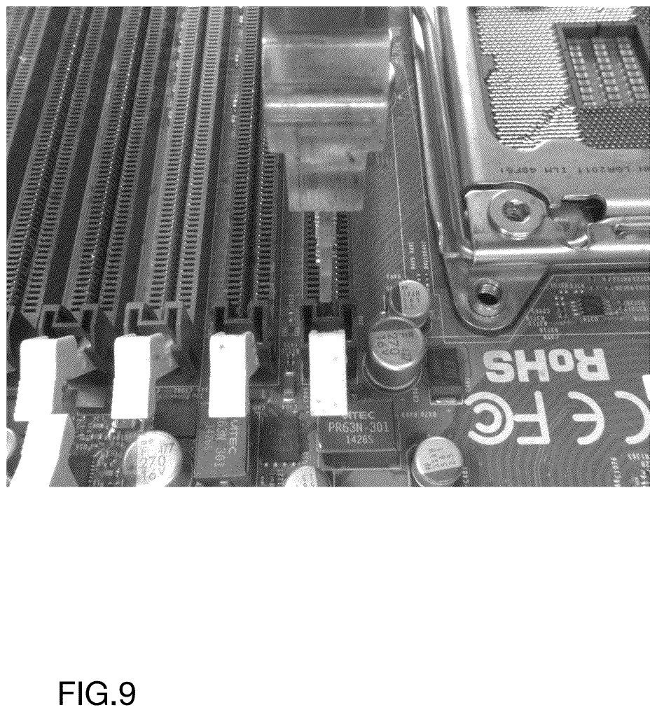

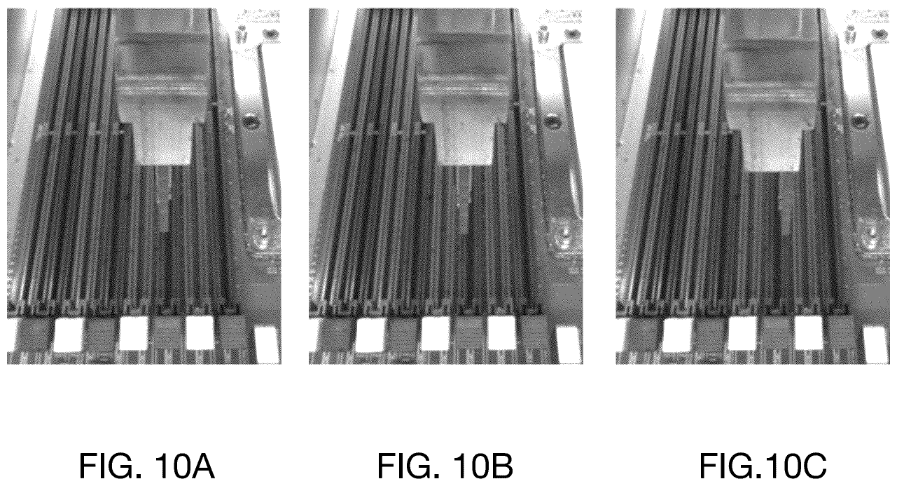

FIG. 2C is one embodiment of a side view of the simplified end of arm component with tip-view cameras, in the insertion position, showing the focused-in view of the tip-view camera. The camera view at insertion 240 shows that the cameras are set up to see the edges of the component and the socket and see their alignment with respect to each other. This enables the use of the tip-view sensors 220 to add precision for the insertion. It enables compensation for deviations in the socket, the DIMM, or the movement of the end of arm. FIG. 9 is a more detailed illustration of one embodiment of what is seen by a tool-tip camera during a DIMM insertion. FIGS. 10A-C illustrate one embodiment of the use of the tip-view sensor data to provide occlusion-resistant key point detection, as will be discussed in more detail below.

FIG. 2D is one embodiment of a simplified end of arm component with a circle of sensors configuration. In this configuration, a plurality of tip-view sensors are coupled to support structure that is around the end of arm 210. In one embodiment, the circle of sensors 245 may include anywhere between two and twenty sensors. In one embodiment, the circle of sensors 245 is configured to provide a 360 degree close-up view of the component insertion or other action. Although the support structure is illustrated as a circle, it may be any shape that will support sensors in the appropriate positions to detect the insertion/attachment needed. For example, the sensors may be a rectangular or square shape or supported by an X-shaped support structure.

FIG. 2E is an embodiment of a simplified view of an end of arm 270 for inserting a CPU component into a socket. The gripper 275 in this example is configured to pick up a CPU 260 and insert it into the CPU socket 265. In this configuration, the tip-view sensors 250 include sensors 255, to enable a view of the CPU 260 and CPU socket 265 at insertion. In one embodiment, there may be four tip-view sensors in this configuration, to be able to use the tip-view sensor for alignment at all four corners of the socket. FIG. 2F is one embodiment of a partial view of the socket 265 and CPU 260 component for insertion, as seen by one of the tip-view sensors 255 of FIG. 2E, including the tip-view camera view at insertion 277, showing the component and socket alignment.

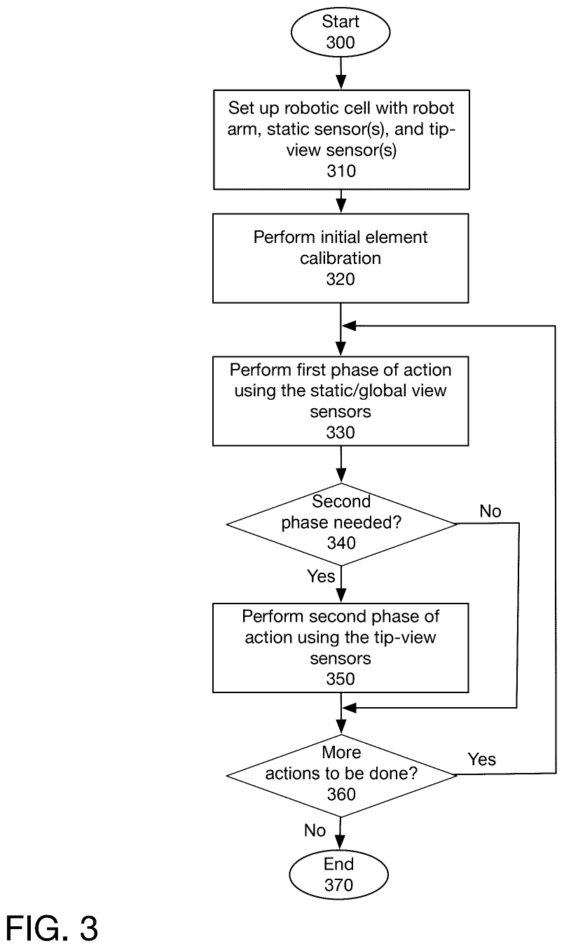

FIG. 3 is an overview flowchart of one embodiment of using the static sensor and the tip-view sensor. The process starts at block 300.

At block 310, the robotic cell is set up, with a robot arm including an appropriate end of arm component for the task for the robotic cell. The setup includes coupling the static sensors to the robotic cell and setting up the tip-view sensors. In one embodiment, the tip-view sensors are coupled to the end of arm in a configuration to provide a view of the positioning of a component being inserted or tool used for assembly.

At block 320, the initial elements are calibrated. Calibrating the static sensors includes determining their location with respect to the workspace of the robotic cell. In order to use static sensor for calibrating the movements of the robot arm, end of arm, or tool, the sensor itself is calibrated first. Calibrating the tool tip sensor includes determining its position relative to the robotic cell frame, and relative to the tool tip of the end of arm.

At block 330 the first phase of an activity is performed, using the static/global view sensors. The first phase of the activity may be a partial calibration of the robot arm, a first portion of a two-phase movement, a first attempt at an assembly activity, or another action. In some embodiment, a combination of the static sensors and tip view sensors may be used for the first phase.

At block 340, the process determines whether the second phase is needed. For some activities, there may only be one phase. For example, if a first phase is a first attempt at insertion, if that first attempt succeeds, there need not be a second phase. If a second phase is needed, at block 350, the second phase of the action is performed using the tip-view sensors. In one embodiment, the second phase may be a fine calibration of the robot arm, the second phase of a two-phase movement, a re-attempt of the assembly activity if the first attempt failed, etc. The process performs the second phase action at block 350. The process then continues to block 360. If no second phase is needed, as determined at block 340, the process continues directly to block 360.

At block 360, the process determines whether there are more actions to be performed by the robotic cell. If so, the process returns to block 330, to perform the first phase of a subsequent action. Otherwise, the process ends at block 370. In this way, the system uses a two-layer sensor configuration

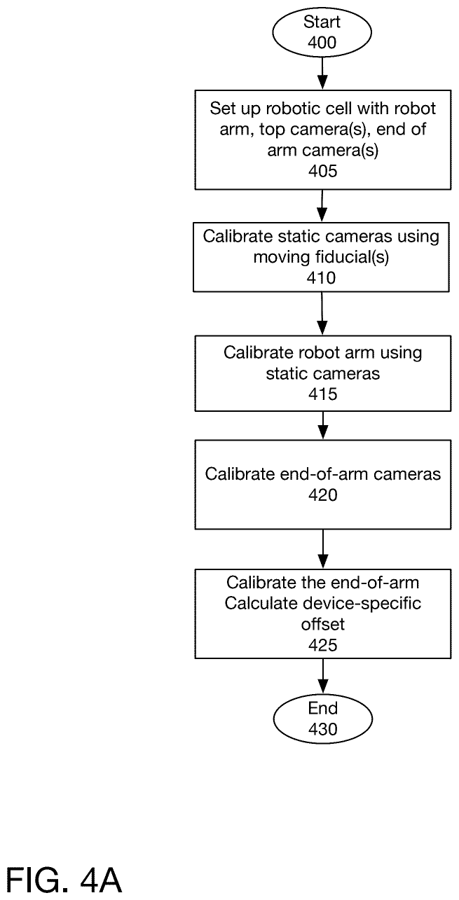

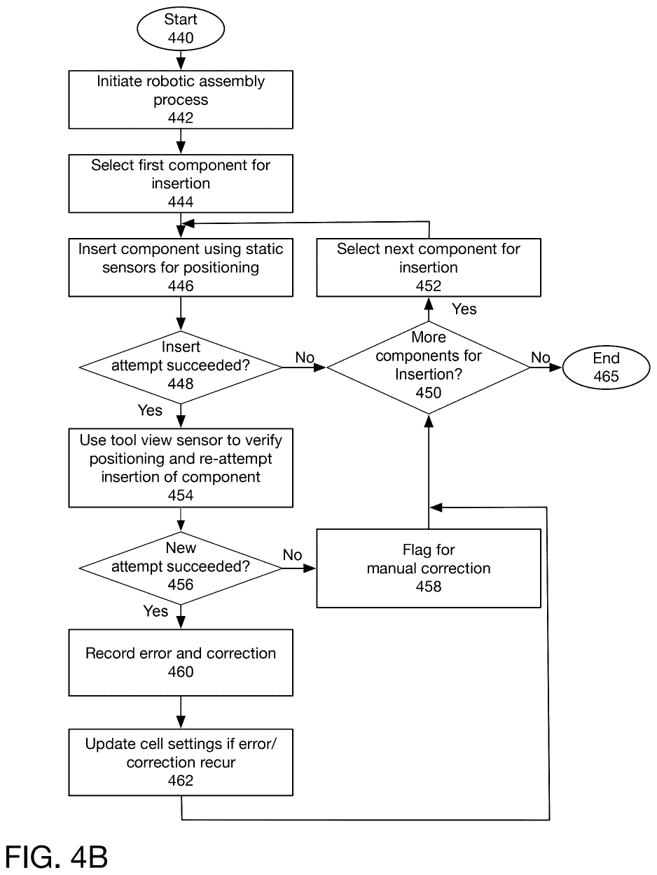

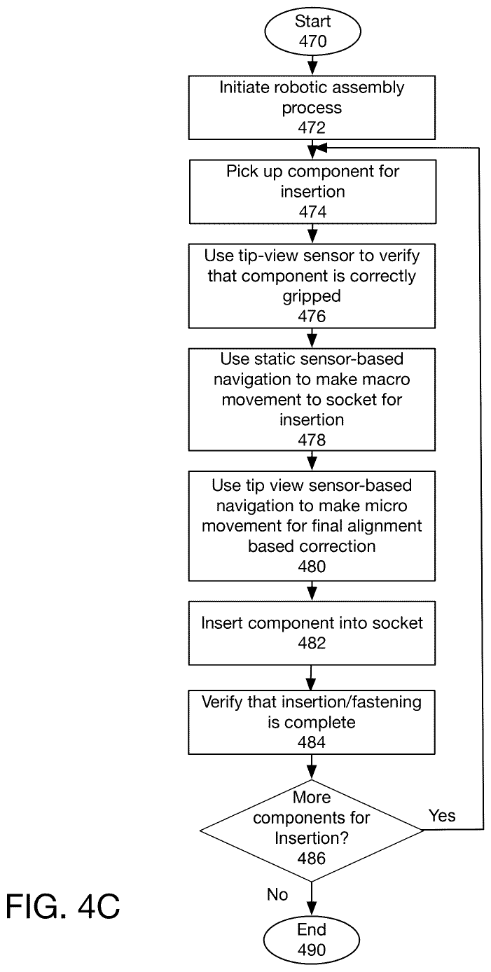

FIG. 4A is a flowchart of one embodiment of the process of using the static sensor and the tip-view sensor for determining an offset for a robotic cell. The offset defines a difference between an actual position and an intended position. Once the offset is identified, it can be used to adjust the movement/position calculation of the robot arm for subsequent insertion or assembly actions, to ensure that the parts are properly aligned for assembly. Each robotic cell may have a per-cell deviation from a “reference robotic cell” due to variations in the components, the environment, or other changes from the reference robotic cell. The offset calculation enables the use of a non-customized recipe by accounting for these deviations from the reference and enabling adjustment of the movements based on the offset calculations. The process starts at block 400. At block 405, the robotic cell is set up, with a robot arm, static sensor(s), and tip-view sensor(s).

At block 410, an initial calibration of the static sensors/top cameras is performed. In one embodiment, before determining the offset the sensors themselves are calibrated. In one embodiment, this is done using any method known in the art. In one embodiment, for cameras, a set of fiducials is used to calibrate the camera sensors. Calibration using the fiducials in one embodiment includes a first calibration using a static fiducial, and a second calibration using a moving fiducial. Because the calibration uses the fiducial pattern, no other component needs to be calibrated to do this.

At block 415, the initial calibration of the robot arm is performed, using the static cameras. This is referred to as the first phase of the calibration. In one embodiment, the first phase of the calibration uses the static/global view sensors to calibrate the tool tip of the robot arm. In one embodiment, one or more fiducials in the work area are used to locate the robot arm, the end of arm, and the tool tip. The fiducials may be stationary components placed in the work area and/or a paddle including one or more fiducials held by the end of arm.

At block 420, the end of arm cameras are calibrated. In one embodiment, this may be done before or after the robot arm calibration. The end of arm sensors are calibrated using fiducials and the static sensors, in one embodiment. FIG. 12 illustrates one embodiment of a static fiducial that may be used in this type of calibration.

At block 425, the second calibration of the end of arm tool of the robot arm is performed. This is referred to as the second phase of the calibration, to calculate the tool tip position and device-specific offset.

Based on the combination of calibration processes, the device-specific offset is calculated for the robotic cell. The device specific offset is used to adjust the recipes and movement patterns for future movement of this particular robotic arm and end of arm in this particular robotic cell. In the real world, each robotic cell varies minutely from the others. Thus, a movement or assembly process step created based on a reference robotic cell is adjusted using the two-phase calibration for the individual robotic cell. This ensures accuracy in the assembly process. The process then ends at block 430.

FIG. 4B is a flowchart of one embodiment of the process of using the static sensor and the tip-view sensor for re-trying a process. The process starts at block 440. At block 442, the robotic assembly is initiated. In one embodiment, the robotic cell performs one step in the robotic assembly process. For the purpose of this flow, the step is an insertion step, inserting a component into a socket. However, one of skill in the art would understand that the assembly step may be inserting components into any type of receptacle, attaching components, affixing components, removing components, opening sockets or other receptacles, etc. The process described can be used regardless of what component is being picked up, moved, inserted, attached, or otherwise assembled.

At block 444, a first component is selected for insertion. In one embodiment, the robot arm picks up a component from a rack, tray, or other storage.

At block 446, the system attempts to insert the component into a socket on a board or another part, using the static sensors for positioning. This is referred to as phase one of the insertion. In one embodiment, the system uses a recipe in which the component held by the robot arm is initially aligned with the socket and then lowered to be inserted into the socket. In one embodiment, one or more sensors are used to verify whether the insertion attempt is successful. In one embodiment, a force sensor on the end of arm is used to control the insertion. If the force sensor indicates a level of force that is above what is expected in inserting a component into a socket, the insertion attempt is stopped and deemed unsuccessful. In one embodiment, the static sensors verify that the socket latches are closed when the insertion is complete. If the socket latching is not successfully verified, the attempt is deemed unsuccessful.

At block 448, the process determines whether the insertion attempt succeeded. The insertion attempt fails if the component is not successfully inserted into the socket and released by the end of arm tool, and/or if the latches are not closed. If the insert attempt succeeded, the process continues to block 450.

At block 450, the process determines whether there are any more components for insertion into this particular part by this robotic cell. If not, the process ends at block 465. Otherwise, the process continues to block 452, and the next component for insertion is selected. The process then returns to block 446, to attempt this next component insertion.

If, at block 448, the process determined that the first insertion attempt did not succeed, the process continues to block 454.

At block 454, the system attempts to re-insert the component into the socket, using the tip-view sensor to correct the alignment of the component. In one embodiment, the system first moves the robot arm to a known starting position and then restarts the insertion process. In one embodiment, the known starting position is a pre-insertion position, in close proximity and aligned with the socket. This is referred to as the second phase of the action. The reinsertion attempt using the tip-view sensor allows for correction for deviations from the expected position or configuration in the socket and/or component. This is designed to enable the system to correct in real-time for any deviations in the robotic cell, the robot arm movement, the component being inserted, or the socket for the component. For example, a component may be slightly bowed, and thus not fit without an adjustment based on the precise position of the component edges. Using the tip-view sensor, the system can detect those edges and ensure correct alignment with the socket.

At block 465, the process determines whether the renewed attempt succeeded. If not, at block 458, the socket and/or component is flagged for manual correction, and the process returns to block 450. In some embodiments, the system attempts the insertion multiple times, prior to flagging the component. In one embodiment, the system attempts to insert the component into another socket, prior to flagging the component as flawed. In one embodiment, the system attempts to insert another component into the same socket, prior to flagging the socket as flawed.

If the renewed attempt succeeded, at block 456, at block 460, the error and correction are recorded. In one embodiment, at block 462, the settings for the robotic cell may be adjusted based on the errors and corrections detected and corrected. For example, it may be that the initially calculated settings have changed, due to an environmental event or change. For example, if the robotic cell is shaken, as in an earthquake, or large object falling nearby, the alignment may be slightly off from what was set at the time of calibration. If the system detects that consistent errors occur, the system may trigger a recalibration of the robotic cell, to update the settings for the robotic cell. In some embodiments, an adjustment to the offsets may be made without a full recalibration. The process then continues to block 450, to determine if any more components need to be inserted.

FIG. 4C is a flowchart of one embodiment of the process of using the static sensor and the tip-view sensor for macro-micro movement. The process starts at block 470. At block 472, the robotic assembly process is initiated. This example flow discusses insertion of a component into a socket, but it should be understood that the same process may be used for any assembly action.

At block 474, the first component is selected for insertion and picked up by an end of arm gripper. The component may be picked up from a rack or tray, which contains multiple components, and is pulled into the robotic cell during the assembly process.

At block 476, the system optionally uses the tip-view sensor to verify that the gripper picked up the component with the correct position. The system verifies whether the end of the arm tool is holding the component correctly by examining a location of a segmented component in the image. The image segmentation identifies the pixels of the image that correspond to the component and analyzes their position. By analyzing a position and alignment of the component within the end of arm tool's gripper, the system can ensure that it is securely and correctly seated. Any misalignment or improper pickup position can be identified by comparing the image to the expected placement of the component within the end of arm, which helps in ensuring optimal functionality and performance of the system.

FIGS. 10A-10C illustrate the difference between a correctly aligned component (FIG. 10A), a component that is slightly off-center (FIG. 10B), and a component that is so misaligned that insertion may not be possible (FIG. 10C). In one embodiment, if the determination is that the component is not in the correct position, the system may return the component to the rack, and re-attempt picking up the component to ensure proper positioning of the component. In another embodiment, the component may be placed aside, and a new component may be picked up. In one embodiment, if the component is not properly positioned within the end of arm, but the misalignment is small, the system may calculate an adjustment to the insertion action, to account for the detected misalignment.

Returning to FIG. 4C, at block 478, a macro movement is made to move the robot arm from an initial position to the pre-insertion position. The macro movement may be made concurrently with the verification that the component is correctly gripped, in block 476. The macro movement is made using the static sensor for navigation. The pre-insertion position in one embodiment is in close proximity to and aligned with the socket, but prior to the component touching the socket. This is referred to as the first phase of the action.

At block 480, a micro movement is made to move the robot arm from the pre-insertion position and complete the insertion of the component into the socket. The tip-view sensor is used for verifying the alignment of the component and the socket, prior to the insertion. The component is then inserted into the socket, at block 482.

At block 484, the process verifies that the insertion/fastening is complete. In one embodiment, for a memory module, the socket latch must be engaged to complete the insertion. The system uses the tip-view camera to confirm that the component is fully seated, and the latch is closed. In one embodiment, for a DIMM module, this is done by examining the segmented DIMM latch in the image. By checking the latch location, the system determines whether the memory module is securely and completely inserted into its slot. This is done using the tip-view sensor because robotic arm and end of arm may make it difficult for the static sensor to see the latch position.

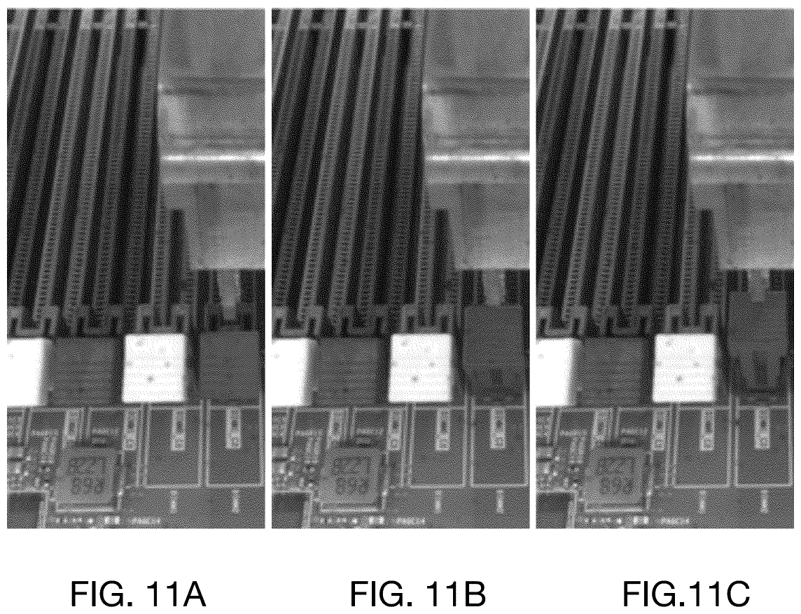

If the latch is in its proper position, it indicates that the DIMM is correctly seated. Any deviation from this alignment may suggest that the memory is not fully inserted, which could affect the system's performance or lead to errors. FIGS. 11A-11C illustrate view of the DIMM latch in the open, partially closed, and fully closed position. Although this example provides verification for a DIMM latch, a similar post-insertion inspection may be made for any type of component, to verify that the insertion has succeeded. If the latch is not fully closed, in one embodiment the end of arm is used to seat the component fully. In one embodiment, if the attempt to fully seat the component and close the latch fails, the process attempts a full insertion, by first removing the component and then attempting to re-insert it.

Returning to FIG. 4C, at block 486, the process determines whether there are more components to be inserted. If so, the process returns to block 474 to select the next component for insertion and pick it up. Otherwise, the process ends at block 490. Any of the processes of FIGS. 4A-4C may be used in the system, or multiple of these processes may be used in any combination. For example, the grip verification and/or insertion confirmation may be used in the process of FIG. 4B, and error-retry may be used with the macro-micro movement of FIG. 4C.

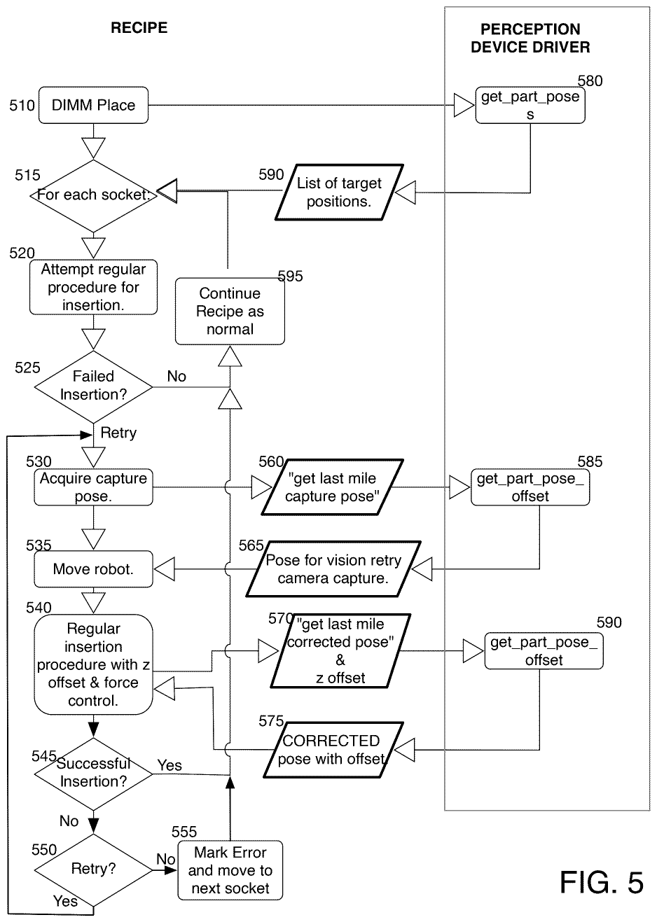

FIG. 5 is a detailed flowchart of one embodiment interaction between the recipe and a vision 3D driver. The recipe provides instructions for the part or whole of the assembly process to be executed. In this example, the recipe is for the placement of a DIMM in a socket.

The recipe is initiated at block 510. A get-part-poses action is taken by the perception device driver. The get-part-poses identifies the position of the sockets into which DIMMs will be placed in this recipe at block 580 and returns the list of target positions at block 590.

For each socket, at block 515, the recipe attempts the regular procedure for insertion, at block 520. The regular procedure for insertion, as discussed above, may be using the static sensors to confirm alignment and insert the DIMM module held by the end of arm into the DIMM socket.

The recipe tests whether the insertion failed, at block 525. If the recipe succeeded, the process continues to block 595 to continue the recipe as normal. This may include picking up the next DIMM for insertion, if any remain, or end the recipe if the last DIMM has been successfully inserted.

If the recipe has been found to have failed, at block 525, the process continues to block 530. At block 530, capture pose is acquired. The instruction “get last mile capture pose” (560) is sent to the perception driver. The perception driver obtains the part_pose_offset, at block 585, and returns the pose for vision retry camera capture (565).

The robot is moved, at block 535, using the pose data from the perception device driver. The system requests last mile corrected post and offset (570) from perception device driver. The perception device driver runs the get_part_pose_offset and returns the corrected pose with offset (575). The insertion is then retried, with the offset and optionally with force control, at block 540. Force control monitors a force sensor. As a component is inserted into a socket, a standard known force curve is expected, with no force on the DIMM component until the insertion starts, then a steady level of force, until the socket springs engage, then a reduction in force, and then leveling out when the insertion is complete. The force control monitors the detected level of force to ensure it matches the force curve.

The process determines whether the insertion was successful, at block 545. If so, the process returns to block 595 to continue the recipe as normal. Ohterwise, the process determines whether it should re-try, at block 550. In one embodiment, the process re-tries the insertion a set number of times—in one embodiment three times. If the process is to retry, it returns to block 530 to start the retry process. Otherwise, the error is marked at block 555, and the process moves to the next socket and continues to block 595 to continue executing the recipe.

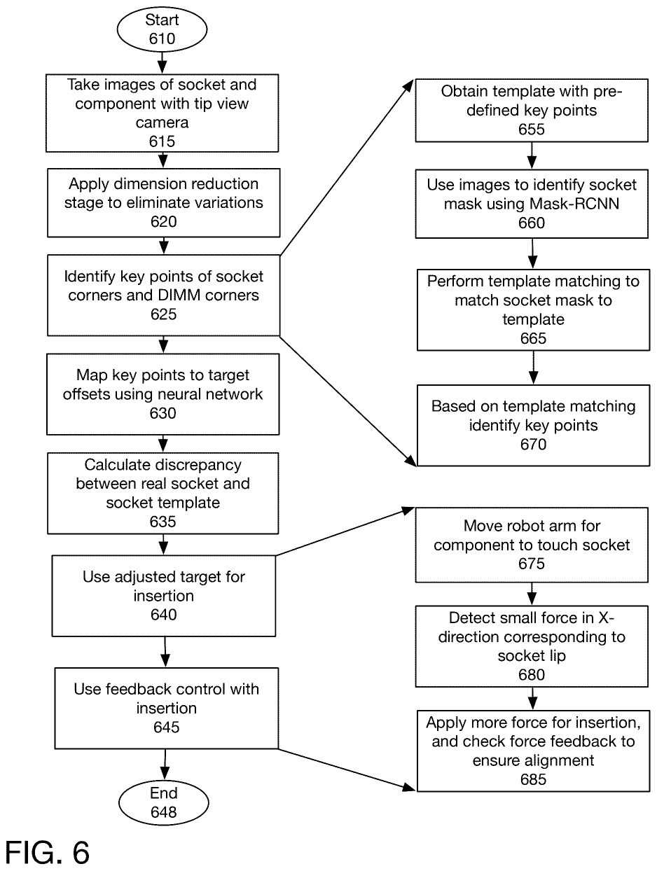

FIG. 6 is a flowchart of one embodiment of the insertion process for a component, using the tip-view sensor. The process starts at block 610. This process corresponds to the tip-view camera assisted insertion step in the above flowcharts, in one embodiment.

At block 615, the tip-view camera takes one or more images of the socket and component. In one embodiment, this occurs after the socket and component are aligned using the static camera. FIG. 9 illustrates an exemplary image taken by one of the tip-view cameras, showing a DIMM board aligned to a socket.

At block 620, a dimension reduction is applied to the image. The dimension reduction transforms the image data from a high dimensional space into a low dimensional space. The dimension reduction processes the image to generate set of relevant key points for simplifying analysis. This reduces the image size and complexity and makes subsequent analysis simpler.

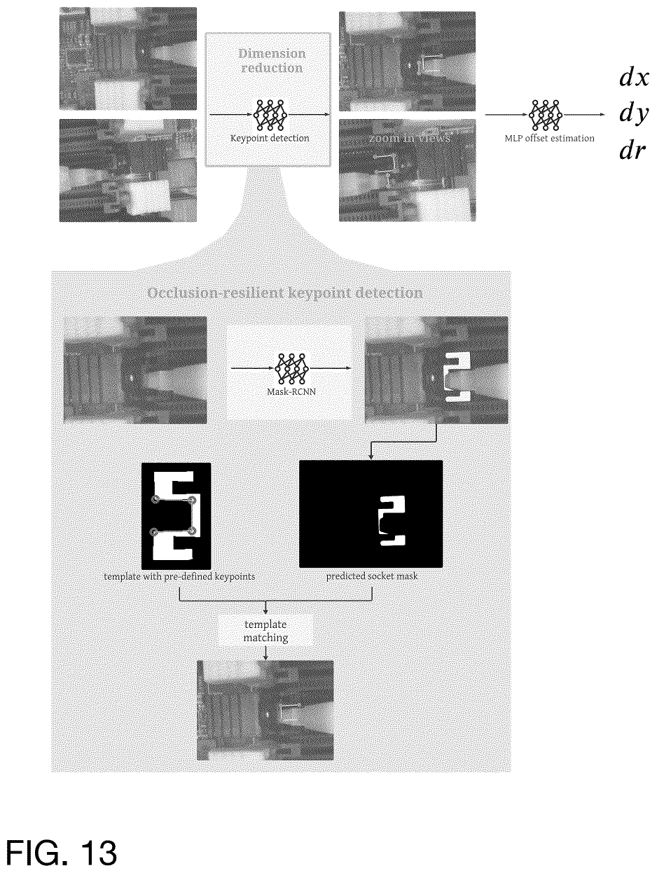

At block 625, key points of the socket corners and the DIMM corners are identified. Key points are pre-defined key point locations which are used for alignment. For example, the key points for a memory module insertion may be the corners or edges of the socket and the DIMM. The key points are defined in a template, stored in memory in one embodiment. In one embodiment, a segmentation method like Mask R-CNN (mask region-based convolutional neural network) is used for key point detection. FIG. 13 illustrates one embodiment of the effect of the dimension reduction and key point detection on the image.

Blocks 655-670 provide an exemplary process for key point detection. At block 655, a template is obtained with the predefined key points. In one embodiment, the template is obtained from a CAD design of the socket and the DIMM board. In one embodiment, a template is initially obtained from a CAD design and then verified with a golden socket/module (reference component that is verified good) during the initial design of the assembly recipe. The template key points are identified, and the template including template key points is provided to the robotic cell.

At block 660, the tip-view images are used to identify the socket mask. The socket mask is identified from the image and defines the socket into which the component is to be inserted. In one embodiment, Mask-R-CNN (Mask Region-based Convolutional Neural Network) architecture is used for this identification.

At block 665, template matching is performed to match the socket mask to the template. This matches the image obtained from the tip-view camera to the template image. Based on the template match, key points are identified in the socket mask, at block 670.

At block 630, the key points on the socket mask are mapped to target offsets using a neural network. In one embodiment a convolutional neural network (CNN) is used. By using the segmentation and template-based identification, the system provides occlusion-resilient key point detection, which can function to identify the components for alignment even if they are partially occluded. The occlusion may be caused by the robotic arm or end of arm which covers a portion of the insertion area from the static sensors positioned on the frame of the robotic cell.

At block 635, the discrepancy is calculated between the real socket and the template. At block 640, the adjusted target is used for insertion. The adjusted target uses the calculated discrepancy, or offset, for aligning the component with the socket. In one embodiment, feedback control is used with the insertion, as noted in block 645. Feedback control in one embodiment utilizes one or more sensors in the end of arm component to ensure that the insertion is successful. In one embodiment, the feedback control is a force sensor. In another embodiment, the feedback control may be a spring or other sensor. The process then ends at block 648.

Blocks 675 to block 685 illustrate one embodiment of insertion using the feedback control.

At block 675, the robot arm is moved so the component touches the socket. At block 680, the small force in the X-direction corresponding to the component touching the socket lip is detected by the feedback control. At block 685, the level of force pushing the component downward is increased slowly, and the feedback control is continuously monitored to ensure that the level of force corresponds to the expected insertion force. The level of force needed to accurately insert a module into a socket is constant and known. If the level of force exceeds that amount, it likely means that there is an issue. The feedback control provides constant feedback about the state of the insertion, beyond the visual feedback of the tip-view camera. The system in one embodiment can stop the insertion, if a force above the threshold is detected the insertion is stopped. In one embodiment, the insertion is re-attempted. In one embodiment, the re-attempt approach described above with the tip view sensor is used. In one embodiment, the process attempts the insertion multiple times, and if it fails, marks the socket and/or component as “faulty,” as described above.

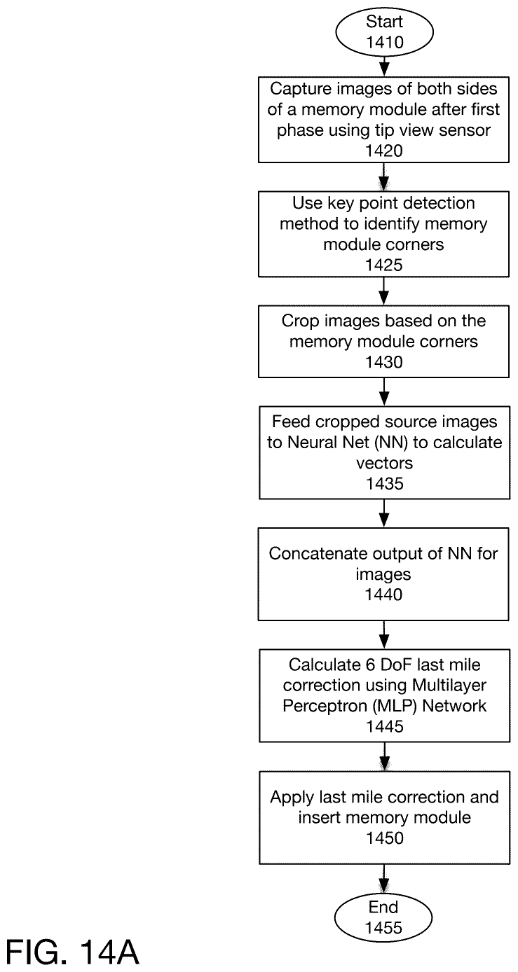

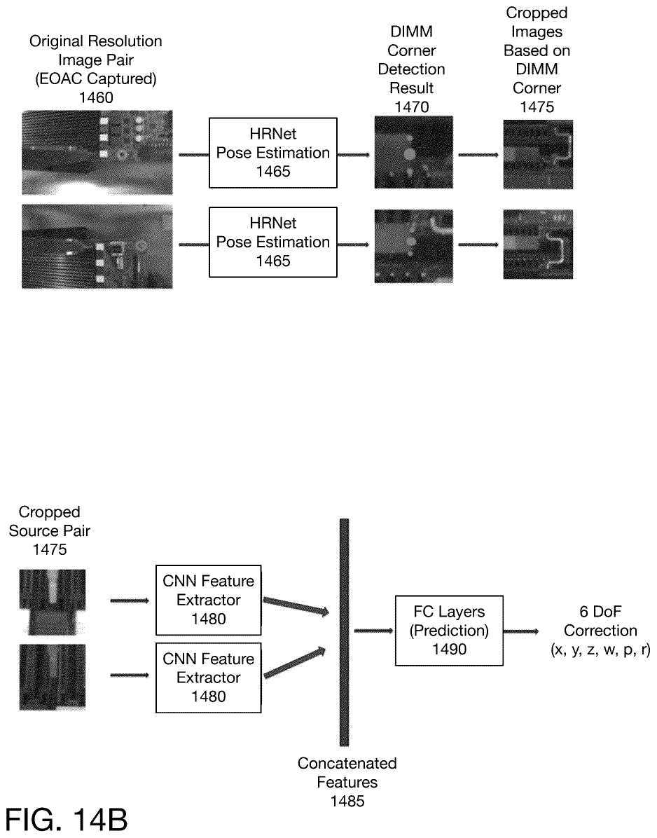

FIG. 14A is a flowchart illustrating an alternative method of calculating an offset. The process starts at block 1410. The described process provides an example for the insertion of a memory module into a socket. One of skill in the art would understand that the same process may be used for any assembly step, including insertion of other components such as CPUs, heat sinks, etc., attachment of components, etc.

At block 1420, images of both sides of a of memory module, after the first phase of movement places the memory module in close proximity to the memory module socket, using the tip view sensor.

At block 1425, a key point detection method is used to identify the corners of the memory module. The key point detection method used may be an adaptive key point detection method such as HRNet Pose Estimation (Deep High-Resolution Representation Learning for Human Pose Estimation).

At block 1430, the images are cropped based on the identified memory module corners. In one embodiment, the images are cropped to 512×512 pixels.

At block 1435, the cropped source images are input into a neural net (NN) to calculate the offset vectors. The neural network in one embodiment is a CNN feature extractor.

At block 1440, the outputs of the neural nets are concatenated for the images. The images are for multiple views of a single component (here a memory module), which have a known/expected relationship. Therefore, the images are concatenated.

At block 1445, the 6 degrees of freedom (6 DoF) last mile correction for the memory module is calculated using a multilayer perceptron (MPL). In some embodiments, the MPL is a fully connected (dense) layers convolutional neural network (CNN). The MPL utilizes the vectors from the concatenated images to determine any necessary offset to be applied to the last movement of the insertion. The offset may have six degrees of freedom (that is it may translate along three axes (forward/backward, left/right, up/down) and rotate around three axes (yaw, pitch, roll).

At block 1450, the last mile correction (or offset) is applied to the recipe, to adjust the alignment of the memory module, and the memory module is inserted into the socket. The process then ends at block 1455. In some embodiments, this process may be used when a first insertion, without the offset calculation, fails. In some other embodiments, this process may be used for every insertion.

FIG. 14B illustrates the system implementing the process of FIG. 14A, including the images captured 1460, the pose estimation 1465, the corner detection 1470, and the cropped images 1475. It also shows the cropped images 1475 being input to CNN feature extractors 1480, concatenated 1485, and input to an FC layers prediction engine 1490, which outputs the 6 DoF correction.

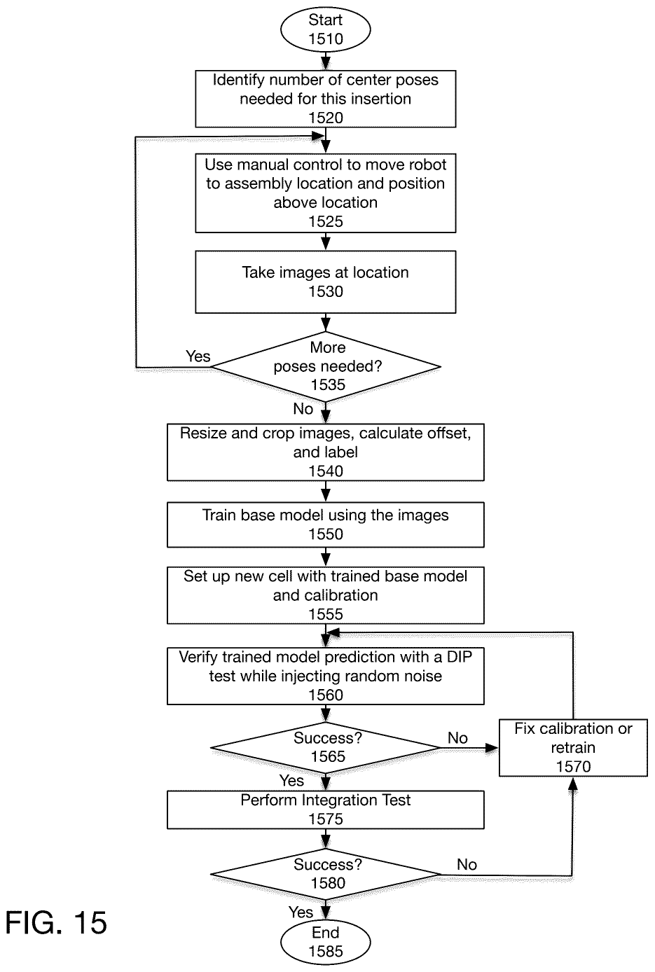

FIG. 15 is a flowchart illustrating one embodiment of training a neural network to calculate the offsets. In one embodiment, this process is used to train the multilayer perceptron (MPL) discussed with respect to FIGS. 14A and 14B. The process starts at block 1510. In one embodiment, prior to the training, the robotic cell is calibrated, and the camera exposure is adjusted.

At block 1520, the number of center poses needed for this training process are identified. In one embodiment, the number of center poses corresponds to the number of locations where this assembly step will take place on the assembled system. For example, for a memory module insertion, this process may be used to locate each of the sockets on a motherboard. In some embodiments, the process may locate one or more sockets/locations in each zone of the board. For example, there may be three zones where multiple memory modules are inserted. The system may identify central poses in each of those zones but may not perform this process for each individual socket.

At block 1525, manual controls are used to move the robot's end of arm to the assembly location, and position it above the assembly location. The assembly location may be a socket, as for a memory module or CPU, or another location where a component will be inserted or attached.

At block 1530, the sensor data is obtained at the location. The sensor data may include images taken with one or more cameras, including tip-view cameras, as well as positioning information for the robot, and the end of arm.

At block 1535, the process determines whether more poses are needed. If so, the process returns to block 1525, to move the robot end of arm to the next assembly location. Once no further poses need to be collected, the process continues to block 1540.

At block 1540, the images are resized and cropped to a per design standardized size that is selected to include the relevant components, including the socket and component, and use case based (sufficient data for the amount of correction to be used. The offset is calculated, and the image is labeled. These images are the training images used by the neural network.

At block 1550, the base model is trained using the images.

At block 1555, a new robotic cell is set up with the trained base model, and an initial calibration is performed. The initial calibration calibrates the static sensors, the tool tip sensors, and the robotic arm itself.

At block 1560, the trained model is verified by using a dip test, with a random noise. The random noise in some embodiments applies uniformly distributed random noise to the x-, y-, and rotation (r-) axes. That is, it creates a change from the expected positioning, in a random way, to test whether the last mile correction can address such random noise. The dip test dips the component into the socket/location, without full insertion. This ensures that the component is not damaged if there is an issue. In some embodiments, the dip test is controlled using a force sensor, stopping the “ip” into the socket/location as soon as the force curve deviates from the expected level, or hits the level just before the component is fully inserted.

At block 1565, the process determines whether the dip test was successful. If it was not successful, the system is updated. The update may include fixing the calibration or retraining the system. In some embodiments, the determination of what correction should be applied is made by the operator and may be determined based on the detected failure mode.

If the dip test was successful, at block 1575, an integration test is performed. The integration test is used to verify that Last Mile Correction (LMC) can function with the production system by performing a full insertion cycle on a plurality of insertion locations and determining whether the correction can handle noise at an acceptable success rate. In one embodiment, in each cycle, a randomized disturbance is applied to the insertion location and LMC is used to make a correction to the insertion location. The integration test measures that LMC can maintain an acceptable rate of successful insertions over a number of insertions. In one embodiment, the system tests 200 locations and verifies that the LMC can maintain ≥98% successful insertions.

At block 1580, the process determines whether the integration test was successful. If the integration test fails, the process continues to block 1570 to apply calibration fixes or retraining. If the integration test is successful, the process ends at block 1585, and the system is deemed ready for use.

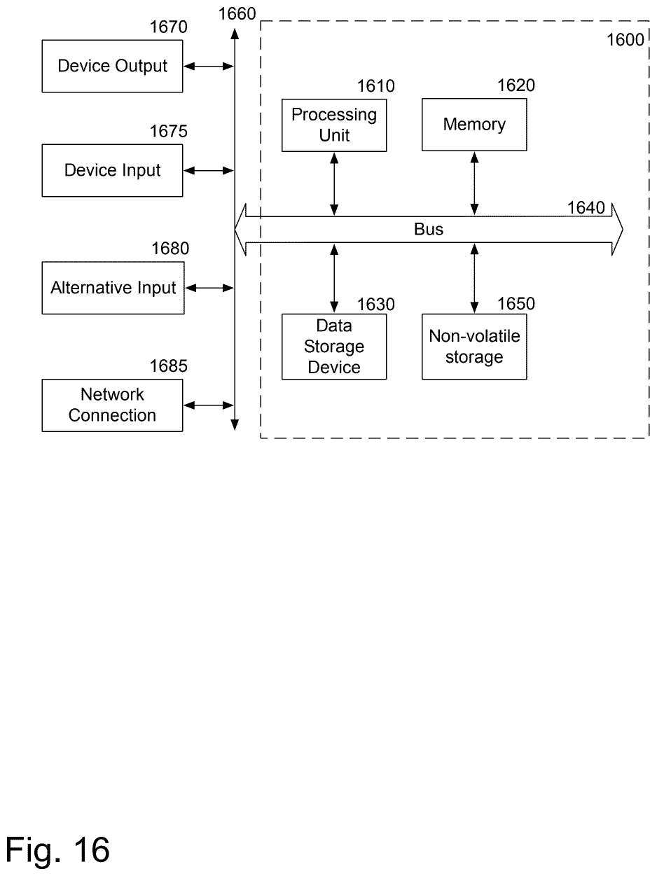

FIG. 16 is a block diagram of one embodiment of a computer system that may be used with the present invention. It will be apparent to those of ordinary skill in the art, however that other alternative systems of various system architectures may also be used.

The data processing system illustrated in FIG. 16 includes a bus or other internal communication means 1640 for communicating information, and a processing unit 1610 coupled to the bus 1640 for processing information. The processing unit 1610 may be a central processing unit (CPU), a digital signal processor (DSP), or another type of processing unit 1610.

The system further includes, in one embodiment, a random access memory (RAM) or other volatile storage device 1620 (referred to as memory), coupled to bus 1640 for storing information and instructions to be executed by processor 1610. Main memory 1620 may also be used for storing temporary variables or other intermediate information during execution of instructions by processing unit 1610.

The system also comprises in one embodiment a read only memory (ROM) 1650 and/or static storage device 1650 coupled to bus 1640 for storing static information and instructions for processor 1610. In one embodiment the system also includes a data storage device 1630 such as a magnetic disk or optical disk and its corresponding disk drive, or Flash memory or other storage which is capable of storing data when no power is supplied to the system. Data storage device 1630 in one embodiment is coupled to bus 1640 for storing information and instructions.

The system may optionally be coupled to an output device 1670, such as a cathode ray tube (CRT) or a liquid crystal display (LCD) coupled to bus 1640 through bus 1660 for outputting information. The output device 1670 may be a visual output device, an audio output device, and/or tactile output device (e.g. vibrations, etc.)

An input device 1675 may be coupled to the bus 1660. The input device 1675 may be an alphanumeric input device, such as a keyboard including alphanumeric and other keys, for enabling a user to communicate information and command selections to processing unit 1610. An additional user input device 1680 may further be included. One such user input device 1680 is cursor control device 1680, such as a mouse, a trackball, stylus, cursor direction keys, or touch screen, may be coupled to bus 1640 through bus 1660 for communicating direction information and command selections to processing unit 1610, and for controlling movement on display device 1670.

Another device, which may optionally be coupled to computer system 1600, is a network device 1685 for accessing other nodes of a distributed system via a network. The communication device 1685 may include any of a number of commercially available networking peripheral devices such as those used for coupling to an Ethernet, token ring, Internet, or wide area network, personal area network, wireless network or other method of accessing other devices. The communication device 1685 may further be a null-modem connection, or any other mechanism that provides connectivity between the computer system 1600 and the outside world.

Note that any or all of the components of this system illustrated in FIG. 16 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1620, mass storage device 1630, or other storage medium locally or remotely accessible to processor 1610.

It will be apparent to those of ordinary skill in the art that the system, method, and process described herein can be implemented as software stored in main memory 1620 or read only memory 1650 and executed by processor 1610. This control logic or software may also be resident on an article of manufacture comprising a computer readable medium having computer readable program code embodied therein and being readable by the mass storage device 1630 and for causing the processor 1610 to operate in accordance with the methods and teachings herein.

The present invention may also be embodied in a special purpose appliance including a subset of the computer hardware components described above. For example, the appliance may include a processing unit 1610, a data storage device 1630, a bus 1640, and memory 1620, and no input/output mechanisms, or only rudimentary communications mechanisms, such as a small touchscreen that permits the user to communicate in a basic manner with the device. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 1685.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1610. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method of compensating for non-deterministic errors and variation in a robotic cell including a robot arm with an end of arm tool, one or more static sensors on the robotic cell, and one or more tip-view sensors on the robot arm, the method comprising:
using the one or more static sensors for targeting movement during a first phase of movement to a first position; and
using the one or more tip-view sensors for targeting the movement during a second phase, images from the tip-view sensors used to adjust for a deviation due to the non-deterministic errors causing a difference between the first position and an intended position.

2. The method of claim 1, wherein the first phase is a first calibration phase, and the second phase is a second calibration phase, to calculate a per-cell offset, to adjust future movement for the robotic cell.

3. The method of claim 1, wherein the first phase is a macro movement moving the end of arm tool into proximity with a target, and the second phase is a micro movement completing alignment of a component with a socket for insertion, to account for a deviation due to the non-deterministic errors.

4. The method of claim 1, wherein the first phase is a first insertion attempt, and the second phase is a re-insertion attempt when the first insertion attempt fails, to account for real-time discrepancies in the robotic cell, a component, or a socket for the component.

5. The method of claim 1, further comprising using the robotic cell to assemble a system, comprising:
using the one or more static sensors to target a movement of the robot arm to a first position for insertion of a component into a socket, the first position in proximity to a socket;
using the tip-view sensors to target a second movement of the end of arm tool to align the component with the socket;
inserting the component into the socket using the end of arm tool.

6. The method of claim 1, further comprising:
inserting a component into a socket using the end of arm tool, using the one or more static sensors to position the end of arm tool for insertion;
detecting a misalignment of the component and the socket;
repositioning the end of arm tool; and
re-inserting the component into the socket, the re-inserting comprising:
activating a tip-view sensor;
using the tip-view sensor to identify a mismatch between the socket and the component;
applying an offset based on the mismatch to a movement of the end of arm tool based; and
inserting the component into the socket.

7. The method of claim 6, wherein the tip-view sensor comprises two miniature cameras on two sides of the end of arm tool.

8. The method of claim 7, wherein the two miniature cameras are aligned to see a portion of the socket and a portion of the component.

9. The method of claim 6, further comprising:
using a force control during the re-insertion, the force control used to sense when the component comes into contact with a lip of the socket.

10. The method of claim 6, wherein using the end of arm camera comprises:
obtaining an image of the socket and the component at a pre-insertion stage;
identifying key points on the component;
identifying the key points on the socket; and
determining the mismatch based on a position of the key points of the socket and the component.

11. The method of claim 10, wherein the key points comprise points defining edges.

12. The method of claim 10, wherein the identifying the key points comprises:
using a template with pre-defined key points;
applying a segmentation method to identify a socket mask; and
detecting the key points in the image, to provide an occlusion-resistant key point detection.

13. The method of claim 12, further comprising:
applying a dimension reduction to the image, prior to the identifying of the key points.

14. The method of claim 6, further comprising:
capturing a plurality of images of a component in proximity to a location;
detecting key points in the plurality of images;
cropping the images around the key points;
using a neural network to calculate vectors for correction; and
calculating a 6-degrees-of-freedom last mile correction using a multilayer perceptron, based on the vectors, the last mile correction applied to the movement.

15. A robotic cell comprising:
a working area;
a robot arm in the working area;
an end of arm tool attached to the robot arm, the end of arm tool used to perform an assembly action;
one or more static sensors coupled to the robotic cell, the one or more static sensors providing a global view of the working area, the one or more static sensors used for targeting movement during a first phase of movement to a first position; and
one or more tip-view sensors, the one or more tip-view sensors providing a close-up of a target, the one or more tip-view sensors for targeting the movement during a second phase, images from the tip-view sensors used to calculate an offset defining a difference between the first position and an intended position.

16. The robotic cell of claim 15, further comprising:
a processor to control movement of the end of arm tool during the assembly action, wherein the processor controls the tool to:
attempt insertion of a component into a socket, using the one or more static sensors to position the end of arm tool for insertion;
detect a misalignment of the component and the socket;
reposition the end of arm tool; and
re-insert the component into the socket, the re-insertion comprising:
activating a tip-view sensor;
using the tip-view sensor to identify a mismatch between the socket and the component;
applying an offset based on the mismatch to a movement of the end of arm tool based; and
inserting the component into the socket.

17. The robotic cell of claim 16, wherein the tip-view sensor comprises two miniature cameras on two sides of the end of arm tool, aligned to see a portion of the socket and a portion of the component.

18. The robotic cell of claim 16, further comprising:
a force sensor used to determine when the component comes into contact with a lip of the socket.

19. The robotic cell of claim 16, further comprising:
the tip-view sensors to obtain an image of the socket and the component at a pre-insertion stage;
the processor to identify key points on the component and determine the mismatch based on a position of the key points of the socket and the component.

20. The robotic cell of claim 19, wherein identifying the key points comprises:
a memory storing a template with pre-defined key points;
the processor further to apply a segmentation method to identify a socket mask; and
the processor to detect the key points in the image, to provide an occlusion-resistant key point detection.

21. The robotic cell of claim 16, further comprising:
the tip-view sensors configured to capture a plurality of images of a component in proximity to a location;
the processor configured to detect key points in the plurality of images, and crop the images around the key points;
a neural network implemented in a computing system to calculate vectors for correction; and
a multilayer perceptron implemented in a computing system to calculate a 6-degrees-of-freedom last mile correction based on the vectors.
